(19) United States
(12) Patent Application Publication
(10) Pub. No.: US 2003/0170554 A1
(43) Pub. Date: Sep. 11, 2003

(54) Photosensitive drum for printing apparatus

(75) Inventors: Yong-Geun Kim, Gyunggi-do (KR); Jin-soo Lee, Gyunggi-do (KR); Yong-baek Yoo, Gyunggi-do (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD.

(21) Appl. No.: 10/305,960

(22) Filed: Nov. 29, 2002

(30) Foreign Application Priority Data
Mar. 11, 2002 (KR) 2002-12987

(51) Int. Cl. G03G 5/00

(52) U.S. Cl. 430/56; 430/133; 399/159

(57) ABSTRACT

A photosensitive drum for a printing apparatus includes a drum body, and a photosensitive film attached to an outer circumference of the drum body, the photosensitive film being wound around the outer circumference of the drum body to have an overlapped portion of a predetermined width at both ends thereof.

### BACKGROUND OF THE INVENTION

1. Field of the Invention

The present invention relates to a printing apparatus and, more particularly, to a photosensitive drum for a printing apparatus.

2. Description of the Related Art

FIG. 1 is a view schematically showing a conventional color image printing apparatus. Referring to FIG. 1, a photosensitive belt 10 repeatedly travels in one-side direction, on a surface of which an electrostatic latent image is formed by a beam of light projected from a laser projection unit 11. The electrostatic latent image formed on the photosensitive belt 10 is developed to be a visible image with color developers from color developing units 13a, 13b, 13c, 13d of cyan, magenta, yellow, black being overlapped thereon. The color developing units 13a, 13b, 13c, 13d are consecutively disposed adjacent to the photosensitive belt 10. That is, during a first rotation of the photosensitive belt 10, an electrostatic latent image corresponding to a yellow color is formed by the laser projection unit 11 and is developed by the yellow color developing unit 13c. The developed image is transferred to a transfer belt 15. Such a developing process is performed in an order of magenta, cyan, and black colors such that the colors are respectively overlapped on the transfer belt 15. Accordingly, a color image is completed. Then, the color image is transferred to paper P passing through between the transfer belt 15 and a transfer roller 17. The color image is fixed on the paper P while the paper P passes through a fixing member 19. Finally, the paper P is discharged.

In the conventional color image printing apparatus as constructed above, however, there is a lack of the accuracy in overlapping the four colors at the same point on the transfer belt 15. That is caused due to the meandering of the photosensitive belt 10. As the result, the accuracy of printing is also reduced.

Also, when the photosensitive belt 10 and the transfer belt 15 are integrally formed with each other in order to solve the above problem, it requires an oversized replacement apparatus that occupies a large space. Accordingly, a user experiences inconvenience in replacing the photosensitive belt 10 and the transfer belt 15, and it is also difficult to achieve the compactness of the apparatus.

### SUMMARY OF THE INVENTION

The present invention has been developed in order to solve the above problems of the related art. Accordingly, it is an aspect of the present invention to provide a photosensitive drum for a printing apparatus having a simplified structure by attaching a photosensitive film to a rotating drum body, and an improved structure to obtain a high-quality image.

In order to achieve the above aspect, an apparatus consistent with the present invention relates to a photosensitive drum for a printing apparatus, comprising: a drum body; and a photosensitive film attached to an outer circumference of the drum body, the photosensitive film being wound around the outer circumference of the drum body to have an overlapped portion of a predetermined width at both ends thereof.

In this case, preferably, but not necessarily, the drum body has a receiving concave of a predetermined depth formed on the outer circumference thereof, for receiving the overlapped portion of the photosensitive film therein.

Also, it is desirable that the receiving concave is formed in a parallel relation to an axial direction of the drum body.

Also, preferably, but not necessarily, the receiving concave is formed obliquely with respect to an axial direction of the drum body.

Also, the both ends of the photosensitive film are overlapped by an extent that corresponds to a width of the receiving concave, such that the overlapped portion is received in the receiving concave correspondingly.

Also, at an external end of the overlapped portion is provided with a coating portion coated with a predetermined photosensitive material, the coating portion for being filled in a stepped portion formed due to a difference in the thickness of the overlapped portion and the remaining portion of the photosensitive film.

Also, wherein an outer surface of the photosensitive film exclusive of the overlapped portion is coated with a photosensitive material.

Also, according to another aspect of the present invention, a photosensitive drum for a printing apparatus comprises: a drum body; and a photosensitive film attached to an outer circumference of the drum body, the photosensitive film being wound around the drum body, with both ends of the photosensitive film being oppositely connected to each other.

### BRIEF DESCRIPTION OF THE DRAWINGS

FIG. 1 is a view schematically showing a conventional printing apparatus;

FIG. 2 is a side-sectional view showing a photosensitive drum for a printing apparatus according to a first embodiment of the present invention;

FIG. 3 is a perspective view showing the photosensitive drum of FIG. 2;

FIG. 4 is a perspective view showing the photosensitive drum of FIG. 2 as another modified example;

FIGS. 5A and 5B are partial sectional views showing a photosensitive drum for a printing apparatus according to a second embodiment of the present invention;

FIG. 6A is a perspective view showing the drum body of FIG. 5A;

FIG. 6B is a perspective view showing the drum body of FIG. 5A as another modified example;

FIG. 7 is a partial sectional view showing a photosensitive drum for a printing apparatus according to a third embodiment of the present invention; and

FIG. 8 is a side sectional view showing a photosensitive drum for a printing apparatus according to a fourth embodiment of the present invention.

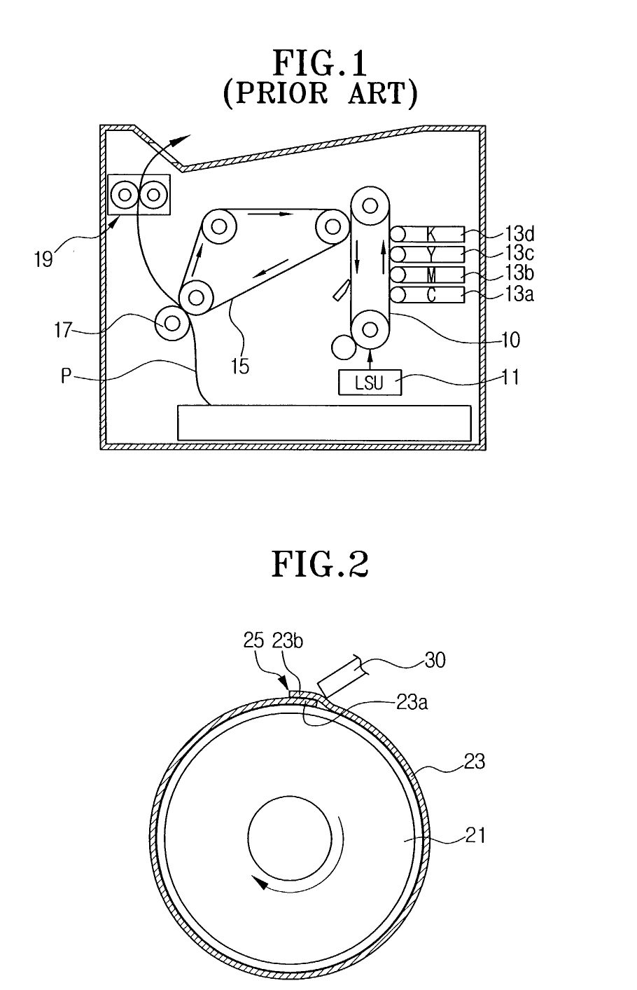

### DETAILED DESCRIPTION OF THE ILLUSTRATIVE, NON-LIMITING EMBODIMENTS

Hereinafter, a photosensitive drum for a printing apparatus according to the illustrative, non-limiting embodiments of the present invention will be described in more detail with reference to the accompanying drawings.

Referring to FIG. 2, according to the first embodiment of the present invention, a photosensitive drum for a printing apparatus comprises a drum body 21 and a photosensitive film 23 wound around an outer circumference of the drum body 21. The drum body 21 is a general cylindrical body having a predetermined external diameter and is made of aluminum.

The photosensitive film 23 is wound around the outer circumference of the drum body 21 and has an overlapped portion 25 where a beginning end 23a and a finishing end 23b are overlapped by a predetermined width. Preferably, but not necessarily, the photosensitive film 23 is wound around the drum body 21 in a direction opposing to an arrow direction shown in FIG. 2 such that the finishing end 23b is disposed above the beginning end 23a. Accordingly, when a cleaning blade 30 contacts a photosensitive drum assembly to clean the photosensitive film 23, the cleaning blade 30 travels over the overlapped portion 25 smoothly and thus under a lower level of a shock.

Also, an outer surface of the photosensitive film 23 excluding the overlapped portion 25 may be coated with a photosensitive material. In this case, the overlapped portion 25 is not coated with the photosensitive material, thereby allowing the cleaning blade 30 to travels more smoothly. Accordingly, there is an advantage in that the shock, which may be repeatedly generated due to the presence of the overlapped portion 25 when the drum body 21 rotates, is reduced.

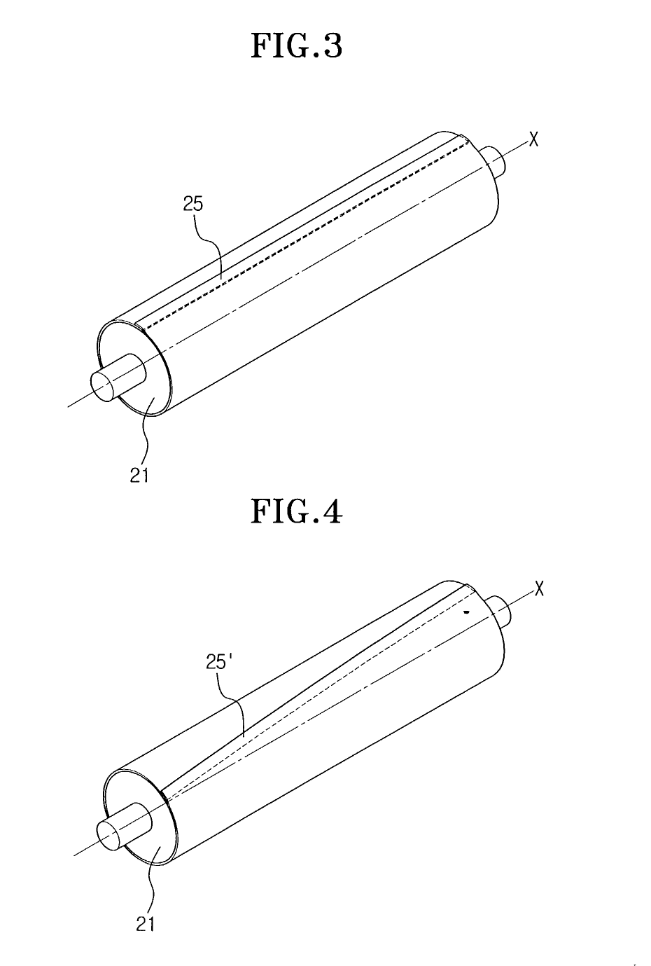

Also, as shown in FIG. 3, the overlapped portion 25 is formed in a parallel relation to an axial direction X of the drum body 21.

However, as shown in FIG. 4, the overlapped portion 25′ may be formed obliquely at a predetermined angle with respect to the axial direction X of the drum body 21. In this case, since an area where the cleaning blade 30 contacts the overlapped portion 25′ per an hour is smaller than in the case of FIG. 3, the shock is reduced.

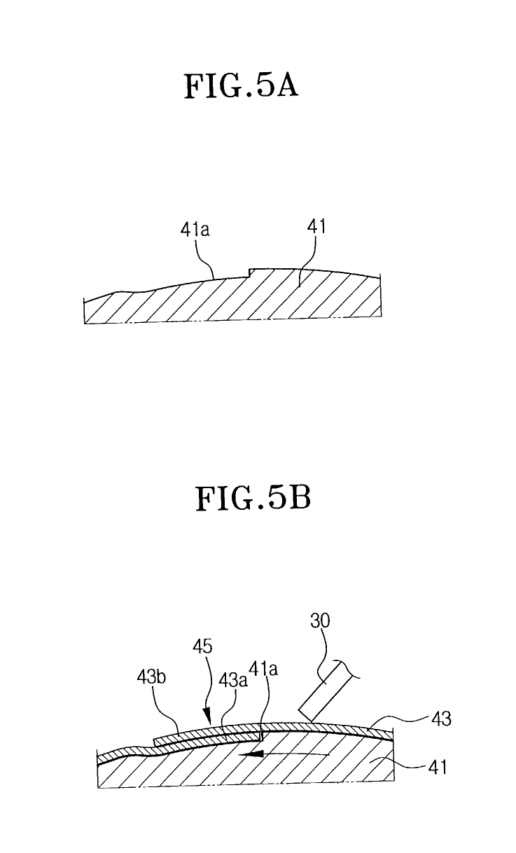

Referring to FIGS. 5A and 5B, a photosensitive drum for a printing apparatus according to the second embodiment of the present invention is characterized in that a receiving concave 41a of a predetermine width is provided on an external circumference of a drum body 41. The receiving concave 41a receives an overlapped portion 45 of a photosensitive film 43 therein. Preferably, but not necessarily, the width of the receiving concave 41a corresponds to a width of the overlapped portion 45. Also, a depth of the receiving concave 41a may correspond to a thickness of the photosensitive film 43. The photosensitive film 43 is wound around the drum body 41 with a beginning end 43a being received in the receiving concave 41a, such that a finishing end 43b is disposed above the beginning end 43a to be at the same height as the external circumference of the drum body 41. Accordingly, the photosensitive drum has a substantially regular arc in a circumferential direction.

Also, the receiving concave 41a has one and the other ends inclined with respect to the external circumference of the drum body 41 steeply and smoothly, respectively. Accordingly, the photosensitive film 43 is wound around the external circumference of the drum body 41 with the beginning end 43a of the photosensitive film 43 being disposed at the end of the receiving concave 41a that is steeply inclined.

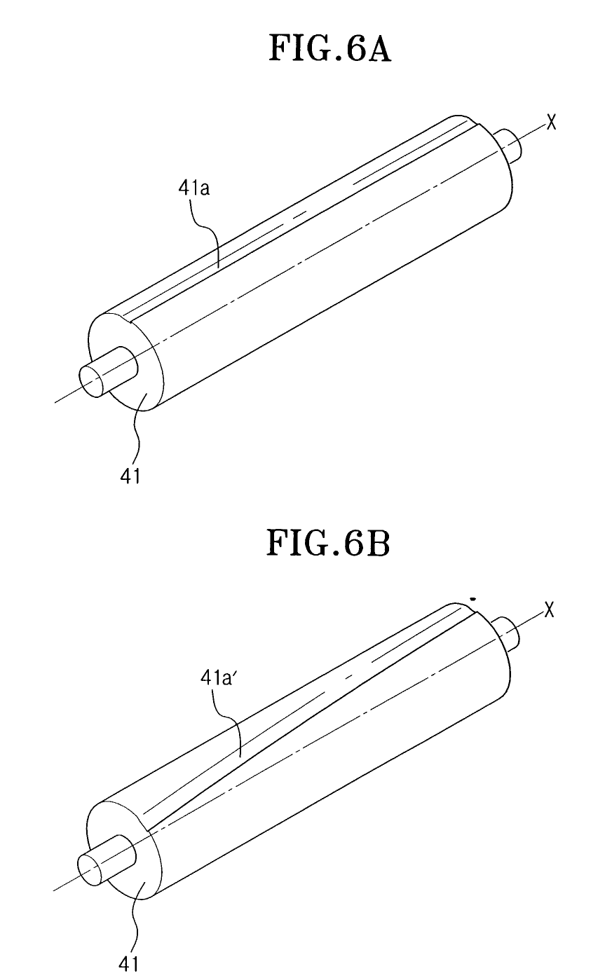

As shown in FIG. 6A, the receiving concave 41a is formed in a parallel relation to an axial direction X of the drum body 41. Just as the receiving concave 41a, the overlapped portion 45 of the photosensitive film 43 is formed in a parallel relation to the axial direction X.

Also, as shown in FIG. 6B, the receiving concave 41a′ may be formed obliquely at a predetermined angle with respect to the axial direction X of the drum body 41. In this case, the overlapped portion 45 of the photosensitive film 43 is formed obliquely to correspond to the receiving concave 41a′.

As described above, the drum body 41 is provided with the receiving concave 41a for receiving the overlapped portion 45 of the photosensitive film 43 therein such that the photosensitive drum has a substantially regular arc in the circumferential direction. Accordingly, when the photosensitive drum is rotated with the cleaning blade 30 contacting thereto, the cleaning blade 30 travels by the overlapped portion 45 smoothly, and thus the shock, which is repeatedly generated in the related art, is prevented.

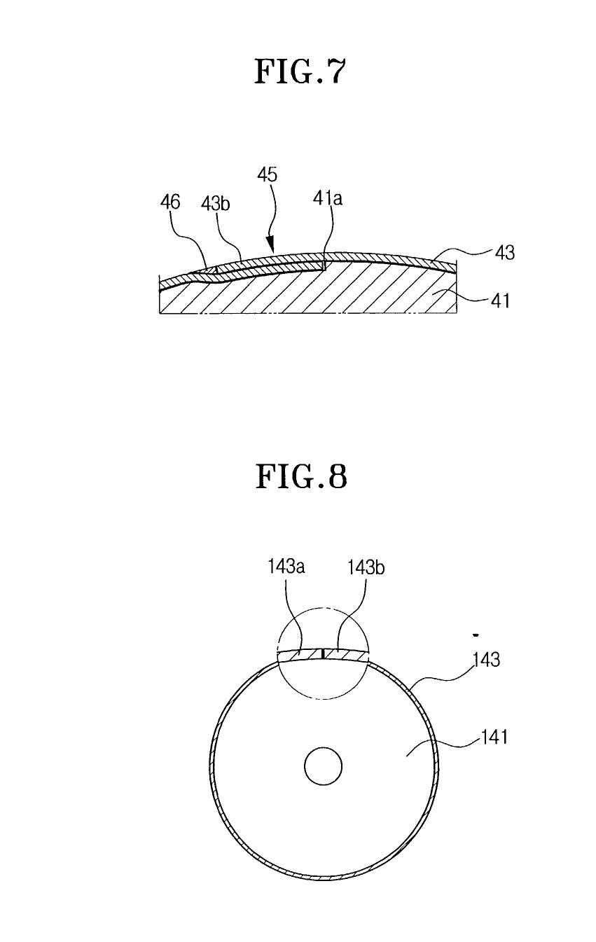

Also, as shown in FIG. 7, a photosensitive drum of a printing apparatus according to the third embodiment of the present invention is characterized by having a coating portion 46 disposed at an external end of an overlapped portion 45 of a photosensitive film 43. The coating portion 46 is coated with a predetermined material, preferably, but not necessarily, a photosensitive material, for being filled in a stepped portion formed at a finishing end of the photosensitive film 43. That is, the stepped portion of the finishing end of the photosensitive film 43 is coated with the photosensitive material such that the photosensitive film 43 has a smooth arc. Accordingly, there is little shock when a cleaning blade contacts the photosensitive film 43. Also, the stepped portion of the finishing end of the photosensitive film 43 may be filled with an adhesive material instead of the coating portion 46.

Also, as shown in FIG. 8, in a photosensitive drum for a printing apparatus according to the fourth embodiment of the present invention, a photosensitive film 143 is disposed on an external circumference of a drum body 141. At this point, both ends 143a and 143b of the photosensitive film 143 are not overlapped but directly connected to each other. The two ends 143a and 143b may be connected to each other by an adhesive. As described above, the photosensitive film 143 is wound around the external circumference of the drum body 141 with the two ends 143a and 143b being directly connected to each other, thereby having a regular external arc in a circumferential direction of the drum body 141. Accordingly, there is an advantage of preventing a shock generated due to a contact of the photosensitive film 143 and a cleaning blade when the drum body rotates.

Although the above embodiments depicted that the photosensitive film 43 contacts the cleaning blade 30, there is a case where the photosensitive drum contacts a developing roller or a transfer roller (not shown). In this case, by minimizing a protruding portion or a bending portion of the outer circumference of the photosensitive drum, the shock, which is repeatedly generated when the photosensitive drum contacts the developing roller or the transfer roller, can be prevented.

Also, as described above, the photosensitive drum according to the first and second embodiments of the present invention has a simplified structure in that the photosensitive film 23, 43 is wound around the drum body 21, 41 instead of a conventional photosensitive belt and thus requires a less space. Accordingly, there are advantages of achieving the compactness of a product and reducing the cost.

Also, since the photosensitive film 23, 43 wound around the drum body 21, 41 rotates without the risk of meandering, it overcomes a disadvantage of a low printing quality, which is caused due to the meandering of the conventional photosensitive belt. That is, various colors are accurately overlapped at a desirable point.

Also, the two ends 23a, 23b, 43a, 43b of the photosensitive film 23, 43 are overlapped such that a shock is reduced when the photosensitive film 23, 43 contacts such the cleaning blade 30.

Especially, the drum body 21, 41 is provided with the receiving concave 41a for receiving the overlapped portion 25, 45 of the photosensitive film 23, 43 therein and supporting the overlapped portion 25, 45, thereby preventing the overlapped portion 25, 45 from protruding from the outer circumference of the drum body 21, 41.

Also, by providing the coating portion 46 at the stepped portion of the external end of the overlapped portion 25, 45, it is possible to achieve a drum body 21, 41 that has a regular arc.

Also, by connecting the two ends 143a, 143b of the photosensitive film 143 directly with each other to have the same height, the both ends 143a, 143b not being overlapped, the drum body 143 of a regular arc can be achieved.

It is contemplated that numerous modifications may be made to the photosensitive drum for a printing apparatus of the present invention without departing from the spirit and scope of the invention as defined in the following claims.

What is claimed is:

1. A photosensitive drum for a printing apparatus, comprising:
a drum body; and
a photosensitive film attached to an outer circumference of the drum body, the photosensitive film being wound around the outer circumference of the drum body to have an overlapped portion of a predetermined width at both ends thereof.

2. The photosensitive drum of claim 1, wherein the drum body has a receiving concave of a predetermined depth formed on the outer circumference thereof, for receiving the overlapped portion of the photosensitive film therein.

3. The photosensitive drum of claim 2, wherein the receiving concave is formed in a parallel relation to an axial direction of the drum body.

4. The photosensitive drum of claim 2, wherein the receiving concave is formed obliquely with respect to an axial direction of the drum body.

5. The photosensitive drum of claim 2, wherein said both ends of the photosensitive film are overlapped by an extent that corresponds to a width of the receiving concave, such that the overlapped portion is received in the receiving concave correspondingly.

6. The photosensitive drum of claim 1, wherein an external end of the overlapped portion is provided with a coating portion coated with a predetermined material, the coating portion for being filled in a stepped portion formed due to a difference in a thickness of the overlapped portion and a remaining portion of the photosensitive film.

7. The photosensitive drum of claim 1, wherein an outer surface of the photosensitive film excluding the overlapped portion is coated with a predetermined material.

8. The photosensitive drum of claim 6, wherein the coating portion is coated with a photosensitive material.

9. The photosensitive drum of claim 1, wherein an external end of the overlapped portion is provided an adhesive for being filled in a stepped portion formed due to a difference in a thickness of the overlapped portion and a remaining portion of the photosensitive film.

10. A photosensitive drum for a printing apparatus, comprising:
a drum body; and
a photosensitive film attached to an outer circumference of the drum body and being wound around the drum body, with both ends of the photosensitive film being directly connected with each other.
